(19) United States
(12) Patent Application Publication
(10) Pub. No.: US 2009/0091588 A1
(43) Pub. Date: Apr. 9, 2009

(54) LIQUID CRYSTAL DRIVING METHOD AND CIRCUIT

(75) Inventors: Yu-Yeh CHEN, Tainan County (TW); Kuo-Shiuan PENG, Tainan County (TW); Mao-Nan LEE, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/245,997

(22) Filed: Oct. 6, 2008

(30) Foreign Application Priority Data
Oct. 4, 2007 (TW) 96137256

(51) Int. Cl. G09G 5/10; G09G 3/36; G09G 5/02

(52) U.S. Cl. 345/690; 345/89; 345/601

(57) ABSTRACT

In a liquid crystal driving method and circuit, a pixel of a display is driven from an initial pixel value associated with a previous frame to a target pixel value of a current frame by an overdrive gray value. The overdrive gray value is determined by an overdrive curve, the initial pixel value, and the target pixel value. The overdrive curve is simulated from a polynomial function.

This application claims the benefit of Taiwan application Serial No. 96137256, filed Oct. 4, 2007, the entire subject matter of which is incorporated herein by reference.

### BACKGROUND

The disclosure relates to a liquid crystal driving method and circuit.

Conventionally, liquid crystal displays (LCDs) response slowly to external driving voltages. Due to the slow response of liquid crystal molecules, there is an obvious vision defect that the pixels cannot reach the target brightness within a frame-time in response to motion picture data. In order to accelerate the response time of a liquid crystal display, in methods known to the inventor(s) as overdrive methods, an initial gray level of a pixel is converted to a higher gray level on purpose and then transmitted to the data driver of that pixel; then the response of liquid crystal in the pixel will be improved. An overdrive look-up table is utilized to achieve overdrive purposes. The overdrive look-up table could be stored in an external memory device.

FIG. 1 is a schematic diagram of an overdrive look-up table for use in a method of overdriving liquid crystal cells known to the inventor(s) as capable of achieving overdrive purposes. As shown in FIG. 1, in the over-drive (OD) look-up table (LUT) of the known overdrive method, the initial gray values (previous gray values) of the data of the previous frame are arranged in the Y-axis, the target gray values (current gray values) of the data of the current frame are arranged in the X-axis, and the correction values for the overdrive operation are disposed at where the X-axis and the Y-axis cross each other. The OD LUT is utilized to provide higher voltages to overdrive the liquid crystal cells in order to improve the response of the liquid crystal molecules. Generally speaking, the liquid crystal display device can display 256 different gray scales within one sub-pixel (e.g., 0, 1, 2, 3 . . . 254, and 255). Basically, there exist 255 different initial gray values and 255 different target gray values. Hence, there exist 255*255 different over-drive values which can cause a significant increase in manufacturing cost and memory size. In order to solve the problem, the initial gray values (previous gray values) of the data of the previous frame and the target gray values (current gray values) of the data of the current frame are divided into several sections. As shown in FIG. 1, the initial gray values from 0 gray level to 8 gray level are grouped as a first initial gray value section, the initial gray values from 9 gray level to 16 gray level are grouped as a second initial gray value section, . . . etc. Similarly, the target gray values from 0 gray level to 8 gray level are grouped as a first target gray value section, the target gray values from 9 gray level to 16 gray level are grouped as a second target gray value section, . . . etc.

In the known look-up table, the interval between the lowest and highest gray levels of each initial gray value section is the same as the interval between the lowest and highest gray levels of each target gray value section. The overdrive gray values are disposed where the initial gray value sections and the target gray value sections cross each other, i.e., at OD(1,1) through OD (32,32) in FIG. 1. In each OD(i,j), overdrive gray values are specified only for a few points and then interpolation is used to calculate the overdrive gray values for the whole section OD(i,j). Hence the look-up table must be a matrix of N*N form. As described above, overdrive gray values are disposed where each initial gray value section containing 8 gray levels and each target gray value section containing 8 gray levels cross each other. Interpolation can be used to determine the overdrive gray values for initial and target gray levels not specified in the lookup table. As shown FIG. 1, if the value of N is increased, the required capacity of the frame buffer and the size of the look-up table will be increased. The number N can be set for 32 (FIG. 1) or 16 because it is advantageous in that the design of the hardware is simple and easy to implement the overdrive technique without any determining rules or mechanism.

In order to reduce the manufacturing cost, the number N in the known technique could not be too big because the target gray scale luminance cannot be reached within a predetermined time interval or can be over the maximum value of the target gray scale luminance. On the one hand, if the target gray scale luminance cannot be reached, it means that the response time of the liquid crystal molecules is insufficiently improved. On the other hand, if the target gray scale luminance is over the maximum value, the display quality will deteriorate and color shift problems and/or undesirable white balance effects may occur.

### BRIEF DESCRIPTION OF THE DRAWINGS

One or more embodiments are illustrated by way of example, and not by limitation, in the figures of the accompanying drawings, wherein elements having the same reference numeral designations represent like elements throughout.

FIG. 1 is a schematic diagram of an overdrive look-up table showing a known method of overdriving liquid crystal cells to achieve overdrive purposes.

FIG. 2 is a schematic diagram showing overdrive curves of a liquid crystal display (LCD) device according to the known method.

FIGS. 3a˜3d are schematic diagrams showing the second-order piecewise characteristics of the overdrive curve with the zero initial gray value according to an embodiment of the present invention.

FIG. 4 is a schematic diagram showing the overdrive curve with the target gray value, the initial gray value, and the judge points according to an embodiment of the present invention.

FIG. 5 is a schematic diagram showing the overdrive look-up table according to an embodiment of the present invention.

FIG. 6 is a schematic diagram showing the functional block of the liquid crystal driving circuit according to an embodiment of the present invention.

FIG. 7 is a schematic diagram showing the functional block of the liquid crystal driving circuit according to another embodiment of the present invention.

FIG. 8 is a schematic diagram showing the flow chart of the liquid crystal driving method according to an embodiment of the present invention.

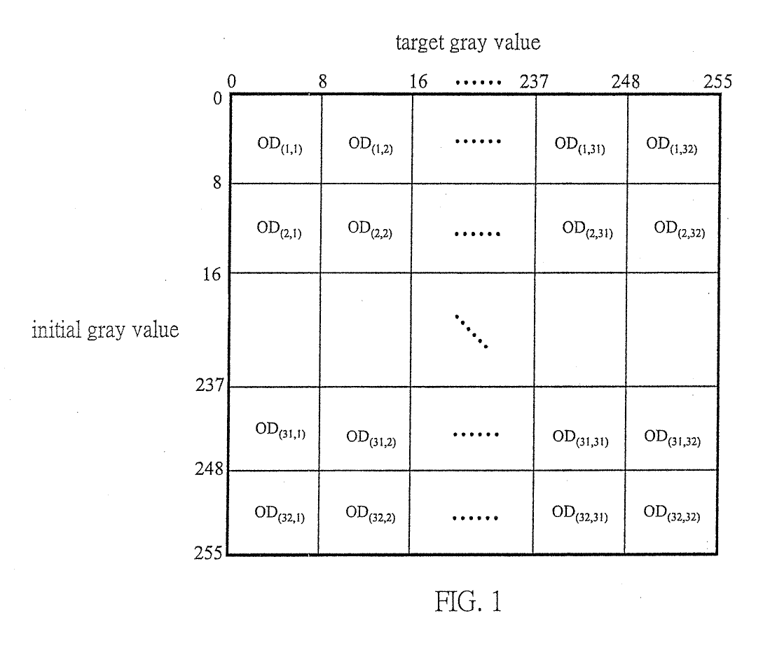

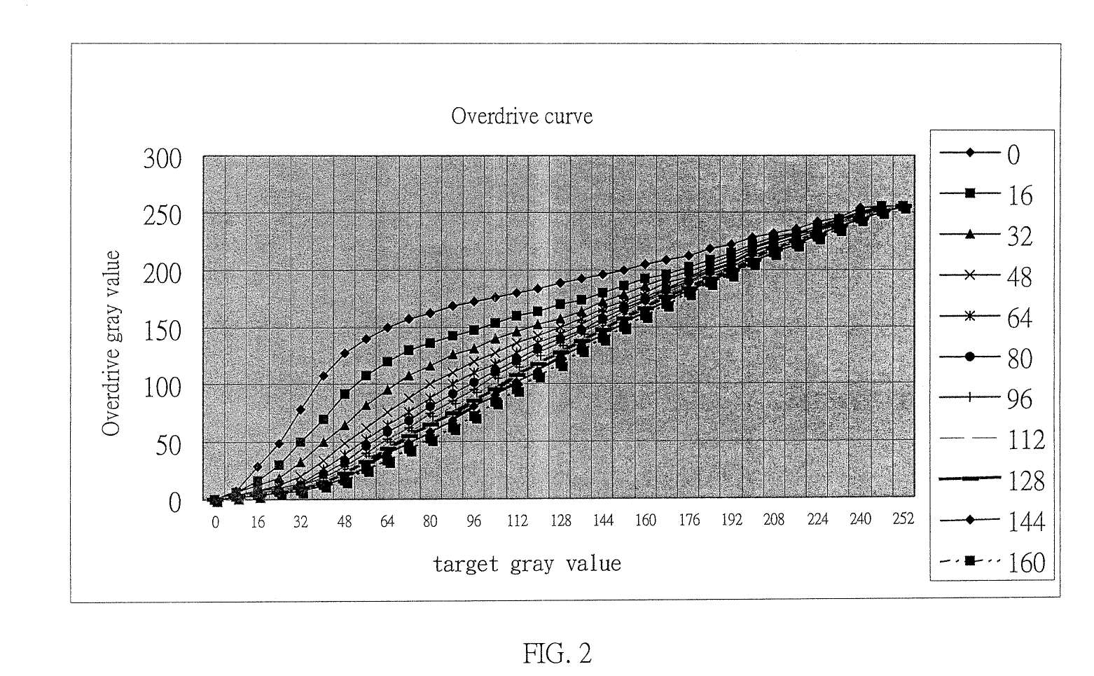

### DETAILED DESCRIPTION OF EMBODIMENTS

Referring to FIG. 2, a schematic diagram showing overdrive curves of a known liquid crystal display device is illustrated. As shown in FIG. 2, different initial gray values (i.e., 0, 16, 32, . . . 160) and different target gray values (abscissas) correspond to different overdrive curves (ordinates). According to the overdrive curves as shown in FIG. 2, the overdrive curves have the second-order piecewise characteristic which can be utilized to configure the liquid crystal driving method and circuit in accordance with embodiments of the present invention. The circuit is hardwired in some embodiments and programmed hardware in other embodiments, and both in further embodiments.

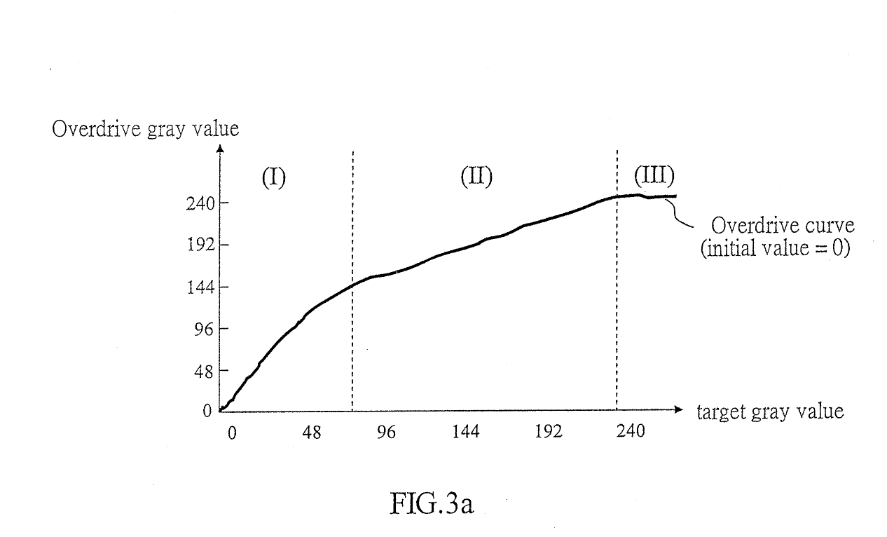

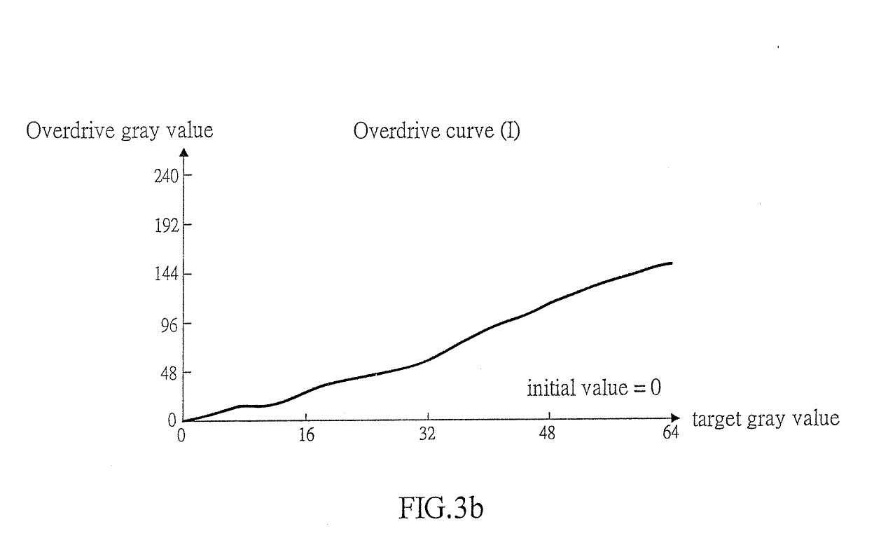

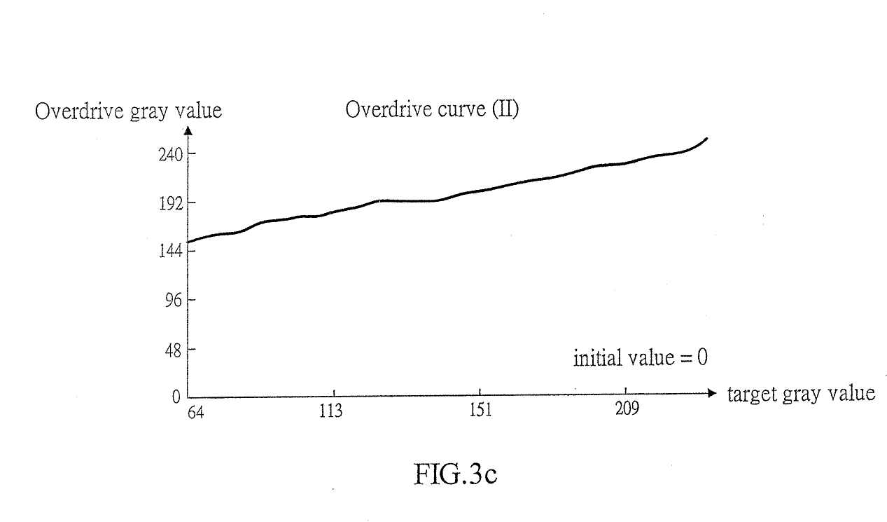

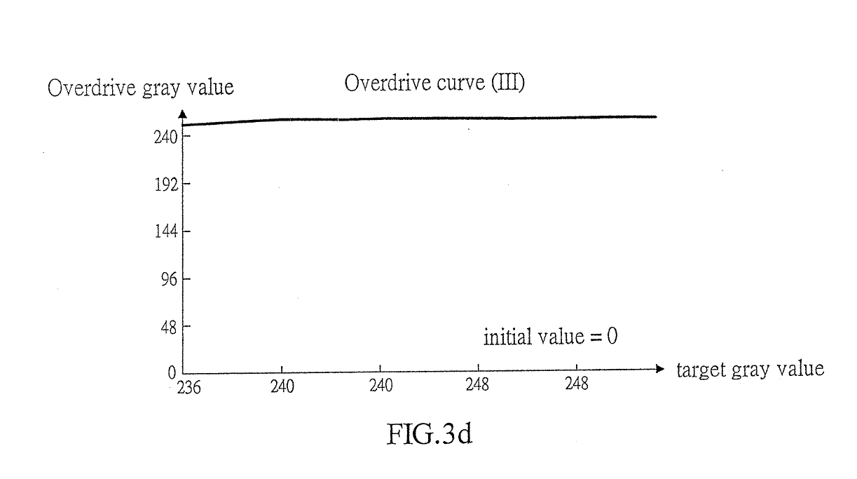

Referring to FIGS. 3a˜3d, schematic diagrams showing the second-order piecewise characteristic of the overdrive curve with the zero initial gray value according to an embodiment of the present invention is illustrated. As shown in FIG. 3a, the overdrive curve in which the initial gray value is zero can be divided into three second-order piecewise sections I, II, and III by two judge points, e.g., with target gray values of 64 and 236. The three second-order piecewise sections I (FIG. 3b), II (FIG. 3c), and III (FIG. 3d) can be approximated by (i) the target gray values of four points, namely, the two judge points, the starting point (e.g., with the target gray value of zero) and the ending point (e.g., with the target gray value of 255) of the overdrive curve, and (ii) three second-order polynomial curves which can be expressed by the second-order polynomial equation Y=ax²+bx+c. The three second-order polynomial equations have different parameters a, b, c wherein the variable “x” represents the target gray value and variable “Y” represents the overdrive gray value. The known parameters a, b, and c for each second-order piecewise section I, II or III are stored in an overdrive look-up table. As shown in FIG. 2, there actually exist 256 overdrive curves. However, there are some overdrive curves that overlap or are too close to each other such that about ten or more representative overdrive curves should be sufficient to represent all overdrive curves. Accordingly, the overdrive look-up table in accordance with an embodiment of the present invention is built by the representative overdrive curves and the piecewise method. As a result, the overdrive look-up table can be utilized to achieve the overdrive effect. Therefore, embodiments of the present invention can reduce the complexity of hardware and the size of the necessary memory.

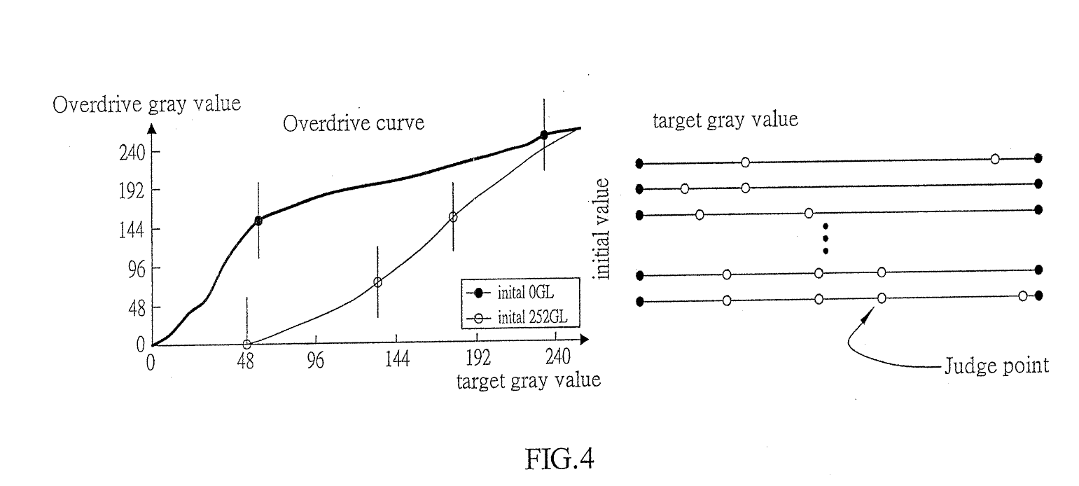

Referring to FIG. 4, a schematic diagram showing the overdrive curve with the target gray value, the initial gray value, and the judge points according to an embodiment of the present invention is illustrated. As shown in FIG. 4, the overdrive curve with different initial gray values can be simulated by three or more piecewise curves. If three piecewise curves are utilized to approximate the corresponding overdrive curve, there will exist two judge points. If four piecewise curves are utilized to approximate the corresponding overdrive curve, there will exist three judge points. If five piecewise curves are utilized to approximate the corresponding overdrive curve, there will exist four judge points. The judges points as well as their number need not be the same for overdrive curves with different initial gray values. Further, certain piece wise curves (e.g., FIG. 3d) can be approximated by a linear (first order) characteristic rather than by a second order characteristic as disclosed above. Likewise, higher-order (i.e., third-order and higher) characteristics may be used. Other arrangements, such as non-polynomial approximation, are not excluded.

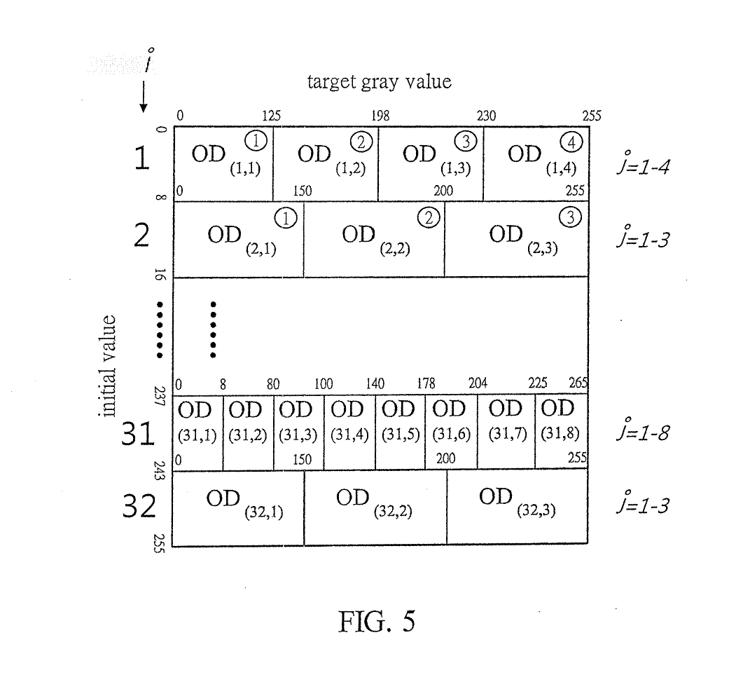

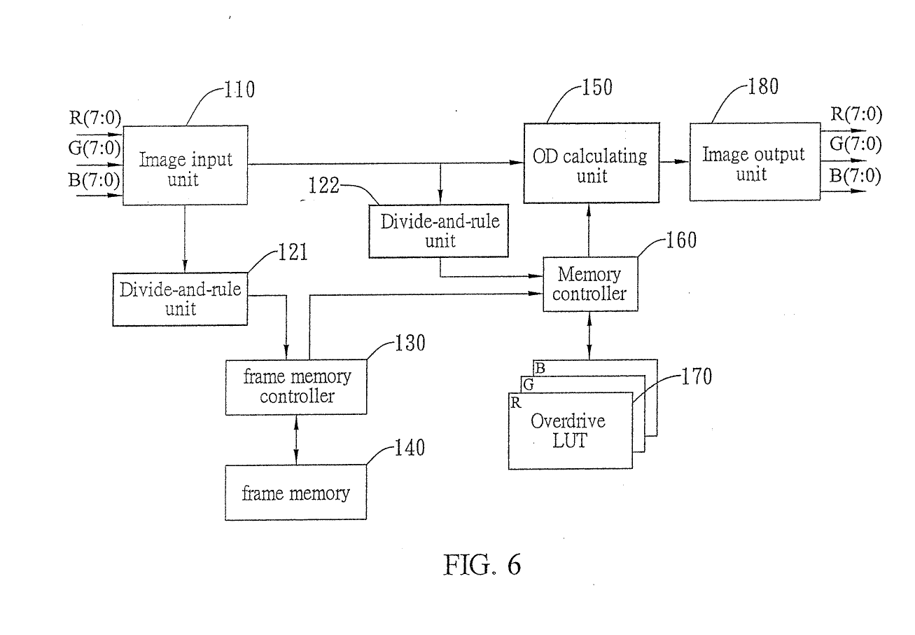

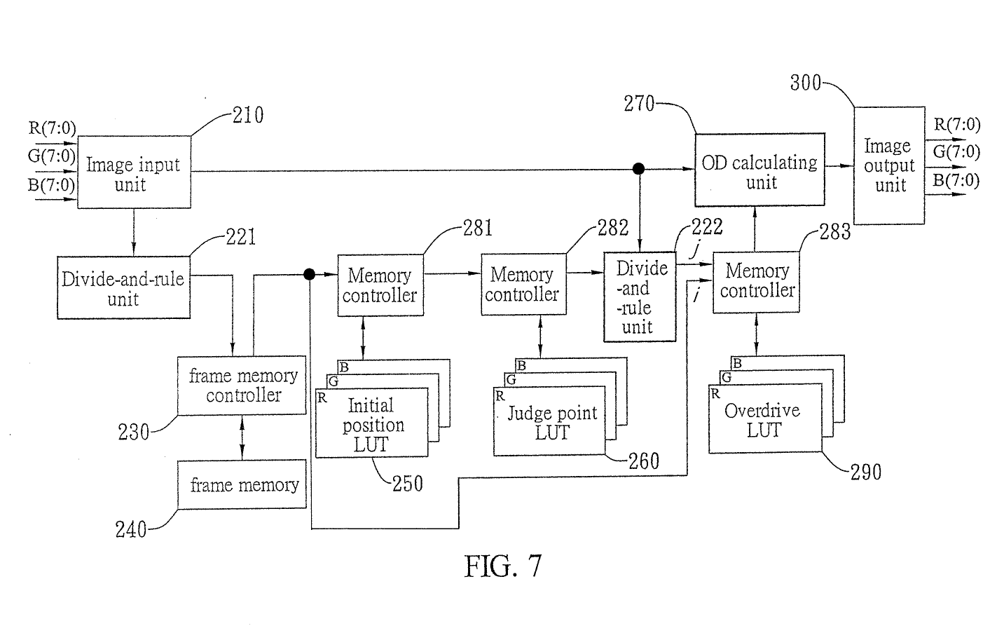

Referring to FIG. 5, a schematic diagram showing the overdrive look-up table according to an embodiment of the present invention is illustrated. As shown in FIG. 5, the different initial gray value sections have different section intervals (i.e., the interval between the lowest and highest gray levels in each initial gray value section) and are assigned different section IDs, e.g., i=1, 2, . . . 32. Thus, different initial gray value sections represent different piecewise characteristics to approximate the overdrive curves for different initial gray values. Similarly, the different target gray value sections have different section intervals and section IDs. For example, the first row in FIG. 5 with the section ID of 1 has four different piecewise sections, e.g., OD(1,1), OD(1,2), OD(1,3), and OD(1,4) with the section IDs j=1˜4, whereas the second row in FIG. 5 with the section ID of 2 has three different piecewise sections, e.g., OD(2,1), OD(2,2), OD(2,3) with the section IDs j=1˜3 etc. In other words, the section intervals of the initial gray value sections and the target gray value sections of different overdrive curves are different because the curve characteristics of different overdrive curves are different. In addition, the parameters (e.g., a, b, c) of the piecewise curves of each overdrive curve are stored in the overdrive look-up table, e.g., 170 in FIG. 6 or 290 in FIG. 7.

FIG. 5 shows how many piecewise curves are used to approximate an overdrive curve by the number of sections of the target gray values corresponding to the same initial gray value. FIG. 5 also shows that several close or overlapping overdrive curves are represented by a single approximation characteristic. For example, nine overdrive curves with the initial gray values of 0-8 are approximated by a single approximation characteristic with four piecewise curves OD(1,1) through OD(1,4) and three judge points at the target gray values of 125, 198 and 230. Similarly, six overdrive curves with the initial gray values of 238-243 are approximated by a single approximation characteristic with eight piecewise curves OD(31,1) through OD(31,8) and seven judge points.

Referring to FIG. 6, a schematic diagram showing the functional block of the liquid crystal driving circuit according to an embodiment of the present invention is illustrated.

As shown in FIG. 6, the liquid crystal driving circuit comprises an image input unit 110, first and second divide-and-rule units 121, 122, a frame memory controller 130, a frame memory 140, an overdrive calculating unit 150, a memory controller 160, an overdrive look-up table 170, and an image out unit 180. The image input unit 110 is utilized for receiving an image data. The image data can be gray level image data or color image data. The image data comprises red component data, green component data, and blue component data if the image data are color image data.

At time t1 (not shown), the image input unit 110 receives current image data (e.g., for a pixel in the LCD device) and delivers the current image data to the first divide-and-rule unit 121. The first divide-and-rule unit 121 stores all the initial gray value judge points (e.g., 8, 16, . . . 237, 243 in FIG. 5) and determines, e.g., by utilizing the divide-and-rule method, at which initial gray level section the current image data is located, by comparing the initial gray value judge points with the target gray value(s) of the inputted current image data. The frame memory controller 130 stores the value corresponding to the initial gray level section determined by the first divide-and-rule unit 121 into the frame memory 140 for use as the initial gray level section of the next image data. The frame memory controller 130 also reads out the stored value corresponding to the initial gray level section at which the previous image data inputted at time t0 (not shown and prior to time t1) was located from the frame memory 140, and then delivers the read-out value to the memory controller 160 for use as the initial gray level section of the current image data. In an embodiment, the read-out value is the section ID i of the needed overdrive curve.

The second divide-and-rule unit 122 receives the current image data sent from the image input unit 110.

The second divide-and-rule unit 122 stores all the target gray value judge points (e.g., 150 and 200 for the initial gray value of 16 in FIG. 5) and utilizes the divide-and-rule method to determine at which target gray level section the current image data is located by comparing the target gray value judge points with the target gray value(s) of the inputted current image data.

The memory controller 160 stores the value corresponding to the target gray level section determined by the second divide-and-rule unit 122 into a memory (not shown). In an embodiment, the stored value is the section ID j of the needed piecewise section on the needed overdrive curve. According to (i) the value (e.g., section ID i) corresponding to the initial gray level section at which the previous image data was located and which is provided by frame memory 140 via frame memory controller 130, (ii) the value (e.g., section ID j) corresponding to the target gray level section at which the current image data is located and which is provided by second divide-and-rule unit 122, and (iii) the overdrive look-up table 170, the corresponding piecewise curve (i.e., OD(i,j) in FIG. 5) is determined and the corresponding overdrive gray value is generated by LUT 170 and then sent to the overdrive calculating unit 150. The overdrive calculating unit 150 receives the current image data and the corresponding overdrive gray value generated by the overdrive look-up table 170 and then overdrives the current image data using the corresponding overdrive gray value. The overdriven current image data are delivered to the image output unit 180. The image output unit 180 outputs the overdriven current image data to overdrive the liquid crystal cells.

In the aforementioned embodiment, if the current image data are color image data, the red component image data, the green component image data, and the blue component image data can be processed individually to determine the individual initial gray level sections of the red component image data, the green component image data, and the blue component image data by the divide-and-rule method. For example, the frame memory controller 130 stores three values corresponding to the three initial gray level sections determined by the first divide-and-rule unit 121 into the frame memory 140 for use with the next image data. The frame memory controller 130 also reads out three stored values corresponding to the initial gray level sections at which the red component image data, the green component image data, and the blue component image data of the previous image data were located at time t0, and then delivers the three read-out values to the memory controller 160 for use with the current image data.

Simultaneously, the second divide-and-rule unit 122 receives the three image data components from the image input unit 110 and determines the target gray level sections of the three image data components by the divide-and-rule method. Through the second divide-and-rule unit 122, the target gray level sections of the three image data components can be calculated and then three values corresponding to the calculated sections are delivered to the memory controller 160. According to the values corresponding to the target and initial gray level sections of the current image data and the previous image data, respectively, the individual overdrive values of the red component image data, the green component image data, and the blue component image data are generated by the overdrive look-up table 170 and then sent to the overdrive calculating unit 150. The overdrive calculating unit 150 receives the current image data and the overdrive gray values generated from the overdrive look-up table 170 and then outputs the overdriven image data to the image output unit 180 to drive the liquid crystal display panel.

Additionally, assuming that there are 32 (i.e., 2⁵) overdrive gray level curves, 5-bit data can be utilized to present all initial gray level sections. The information which is stored in the frame memory 140 can be 5-bit data. The frame memory controller 130 reads out the stored 5-bit data and sends the read-out 5-bit data to the memory controller 160.

The second divide-and-rule unit 122 also utilizes 5-bit data to represent the target gray level section(s) at which the current image data is located. The 5-bit data outputted by the second divide-and-rule unit 122 are delivered to the memory controller 160. According to the 5-bit data corresponding to the target gray level section(s) at which the current image data is located and the 5-bit data corresponding to the initial gray level section(s) at which the previous image data was located, the corresponding overdrive gray value(s) is/are read out and delivered to the overdrive calculating unit 150 by the overdrive look-up table 170. The overdrive calculating unit 150 receives the current image data and the overdrive value(s) from the overdrive look-up table 170 and then overdrives the current image data and sends the overdriven current image data to the image output unit 180. The image output unit 180 outputs the overdriven current image data to drive the liquid crystal display panel. Thus, the size of the LUT 170 is significantly decreased to less than half of that in the known arrangement.

Referring to FIG. 7, a schematic diagram showing the functional block of the liquid crystal driving circuit according to another embodiment of the present invention is illustrated. As shown in FIG. 7, the liquid crystal driving circuit comprises an image input unit 210, first and second divide-and-rule units 221, 222, a frame memory controller 230, a frame memory 240, an initial position look-up table 250, a judge point data look-up table 260, an overdrive calculating unit 270, first-third memory controllers 281, 282, 283, an overdrive look-up table 290, and an image out unit 300.

The image input unit 210 receives image data. The image data can be gray level image data or color image data. The image data in some embodiments comprises red component data, green component data, and blue component data if the image data are color image data.

At time t1 (not shown), the image input unit 210 receives current image data and delivers the current image data to the first divide-and-rule unit 221. The first divide-and-rule unit 221 stores all the initial gray value judge points and utilizes the divide-and-rule method to determine at which initial gray level section the current image data is located by comparing the initial gray value judge points with the target gray value(s) of the inputted current image data. The frame memory controller 230 stores the value corresponding to the initial gray level section determined by the first divide-and-rule unit 221 into the frame memory 240. The frame memory controller 230 also reads out the stored value corresponding to the initial gray level section at which the previous image data was located at time t0 (not shown and prior to time t1) from the frame memory 240, and then delivers the read-out value to (a) the third memory controller 283 for use as the initial gray level section of the current image data, and (b) the first memory controller 281 to obtain the respective target gray value judge points as discussed below.

Additionally, assumed that there are 32 (2⁵) overdrive gray level curves, 5-bit data can be utilized to present the initial gray level section at which the current/previous image data is/was located. The information which is stored in the frame memory 240 can be 5-bit data. For example, assuming that the target gray value of the red component of the inputted current image data is 6, the first divide-and-rule unit 221 receives the current target gray value of 6 via the image input unit 210 and outputs the corresponding value of 1 (i.e., the section ID of the initial gray value section 0-7 where the current target gray value of 6 belongs) to the frame memory controller 230. In the binary code, “00001” is inputted from the frame memory controller 230 to the frame memory 240. The frame memory controller 230 also reads out the stored value, e.g., 2, corresponding to the initial gray level section (with the section ID of 2) at which the previous image data was located at time t0 from the frame memory 240, and then delivers the read-out value to the first memory controller 281 as well as the third memory controller 283 for use as the initial gray level section of the current image data. In the binary code, “00010” is inputted from the frame memory controller 230 to the first memory controller 281 and the third memory controller 283.

The first memory controller 281 delivers the 5-bit data read-out, e.g., “00010,” from the frame memory 240 to the initial position look-up table 250, and receives therefrom an input address. The input address is then delivered to the second memory controller 282 which, in turn, delivers the input address to the judge point data look-up table 260. All information of the judge points is stored in the judge point data look-up table 260 and can be found according to the input address which identifies the first target gray value judge point of the overdrive curve needed for the current image data. The remaining target gray value judge point(s) of the needed overdrive curve can be subsequently read-out after the first target gray value judge point. For example, in response to 5-bit data “00001” (section ID i=1) read-out from frame memory 240, the initial position look-up table 250 returns an input address (e.g., “00000000”) indicating where the first target gray value judge point “125” of the first overdrive curve (first row in FIG. 5) is stored in the judge point data look-up table 260. The remaining target gray value judge points, i.e., “198” and “230” residing at addresses “00000001” and “00000010” of the judge point data look-up table 260, can be then subsequently read-out. Further, if 5-bit data “00010” (section ID i=2) is read-out from frame memory 240, the initial position look-up table 250 will return an input address (e.g., “00000011”) indicating where the first target gray value judge point “150” of the second overdrive curve (second row in FIG. 5) is stored in the judge point data look-up table 260. The remaining target gray value judge point, i.e., “200” residing at address “00000100” of the judge point data look-up table 260, can be then subsequently read-out etc. The second memory controller 282 delivers the information of all judge points of the needed overdrive curve to the second divide-and-rule unit 222. For example, in response to the input address corresponding to “00010” read out from the frame memory 240, the judge point data look-up table 260 returns the judge points “150” and “250” (FIG. 5) of the piecewise characteristic having the section ID of 2. The judge points “150” and “250” are then delivered to the second divide-and-rule unit 222 via the second memory controller 282. In some embodiments, the first memory controller 281 and the initial position look-up table 250 are omitted, and the section ID i read-out from the frame memory 240 is directly fed to the second and third memory controllers 282, 283.

The second divide-and-rule unit 222 receives the current image data sent from the image input unit 210. The second divide-and-rule unit 222 receives the information on all judge points of the needed overdrive curve from the second memory controller 282, and utilizes the information of all judge points and the current image data to determine at which target gray level section the current image data is located by the divide-and-rule method. The value corresponding to the target gray level section provided by the second divide-and-rule unit 222 is delivered into the third memory controller 283. In an embodiment, the value is the section ID j of the needed piecewise section on the needed overdrive curve. The third memory controller 283 also receives the section ID i of the needed overdrive curve, which is the value corresponding to the initial gray level section at which the previous image data was located, from the frame memory 240.

According to the value (e.g., section ID i) corresponding to the initial gray level section at which the previous image data was located, and the value (e.g., section ID j) corresponding to the target gray level section at which the current image data is located, the parameters (e.g., a, b, c) of the corresponding polynomial (e.g., OD(i,j)) are read out from the overdrive look-up table 290 and then delivered to the overdrive calculating unit 270. The overdrive calculating unit 270 receives the current image data and the parameters of the corresponding polynomial from the overdrive look-up table 290 and then calculates the overdrive value to overdrive the current image data to be outputted to the image output unit 300. The image output unit 300 outputs the overdriven current image data to drive the liquid crystal display panel. In some embodiments, components 281, 250, 282, and 260 can be configured, structurally and/or functionally, to define a circuit that, in response to the value (e.g., “2”) read-out from frame memory 240, (i) delivers a corresponding set of judge points (e.g., “150” and “250”) to the second divide-and-rule unit 222 and (ii) inputs the information (e.g., section ID i) of the initial gray value section of the previous image data to the third memory controller 283.

In the aforementioned embodiment, if the current image data are color image data, the red component image data, the green component image data, and the blue component image data can be processed individually to determine the individual initial gray level sections of the red component image data, the green component image data, and the blue component image data by the divide-and-rule method. For example, the frame memory controller 230 stores three values corresponding to the three initial gray value sections determined by the first divide-and-rule unit 221 into the frame memory 240 for use with the next image data. The frame memory controller 230 also reads out three stored value corresponding to the initial gray level sections at which the red component image data, the green component image data, and the blue component image data of the previous image data were located at time t0, and then delivers the read-out values to the first memory controller 281 and the third memory controller 283 for use with the current image data.

The second divide-and-rule unit 222 receives the three image data components from the image input unit 210. The second divide-and-rule unit 222 also receives the target gray levels corresponding to the information of all judge points received from the second memory controller 282, and then determines the target gray level sections at which the three image data components are located, e.g., by the divide-and-rule method. The values corresponding to the target gray level sections determined by the second divide-and-rule unit 222 are delivered to the third memory controller 283. According to the values corresponding to the target/initial gray level sections of the current image data and the previous image data, the individual overdrive values of the red component image data, the green component image data, and the blue component image data are generated by the overdrive look-up table 290, and sent to the overdrive calculating unit 270. The overdrive gray value calculating unit 270 receives the current image data and the overdrive gray values generated from the overdrive look-up table 290 and then outputs the overdriven image data to the image output unit 300 to drive the liquid crystal display panel. Compared to the embodiments disclosed with respect to FIG. 6, the embodiments disclosed with respect to FIG. 7 has a smaller the overdrive LUT 290's size. For example, in an embodiment the size of the overdrive LUT 170 in FIG. 6 is 32*32*6 bits for each color. The size of the overdrive LUT 290 in a corresponding embodiment in accordance with FIG. 7 is 32*6*6 bits for each color. The size of the LUT 250 is 32*8 bits for each color. The size of the LUT 260 is 32*6*6 for each color. Therefore, the total size of all LUTs 250, 260, and 290 is less than half of that of the LUT 170. In further embodiments, only one initial position LUT 250 is needed for all three colors, and, likewise, only one judge point LUT 260 is needed for all three colors. Therefore, the total memory size of embodiments of the present invention will be much smaller than that of the known arrangement.

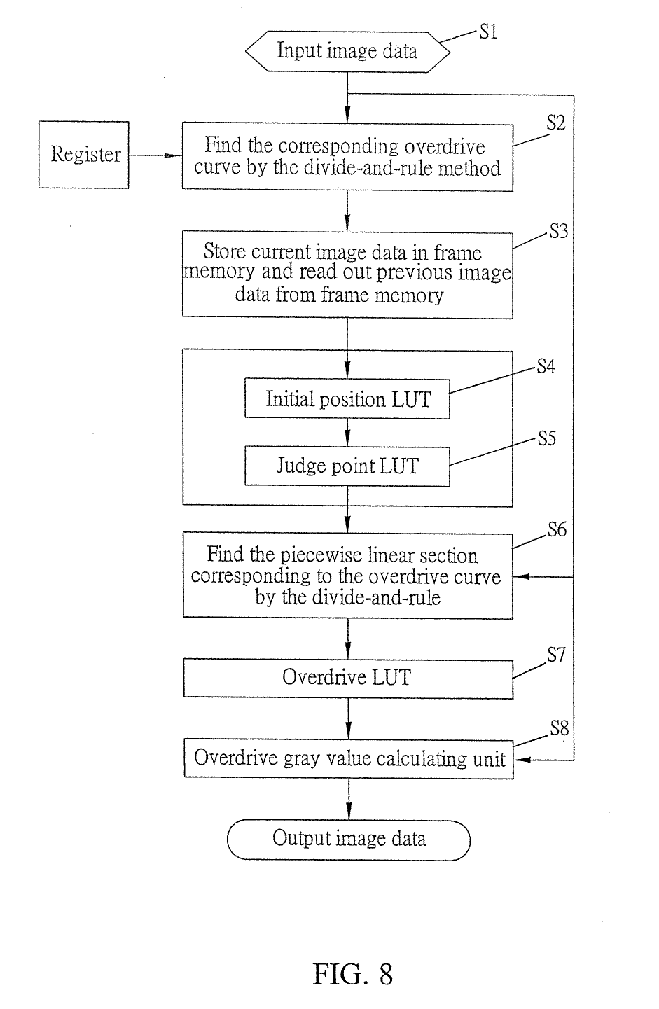

Referring to FIG. 8, a schematic diagram showing the flow chart of the liquid crystal driving method according to an embodiment of the present invention is illustrated. As shown in FIG. 8, at step S1 current image data is received. The current image data can be gray level image data or color image data. The image data comprises, e.g., red component data, green component data, and blue component data if the image data are color image data. A register (which is a part of the first divide-and-rule unit 221) stores all the initial gray value judge points and the divide-and-rule method is utilized to determine at Step S2 at which initial gray level section the current image data is located according to the information of the initial gray value judge points and the inputted current image data. In other words, the corresponding overdrive curve is found according to the information of the initial gray value judge points and the inputted current image data.

The value corresponding to the initial gray level section at which the current image data is located is stored, e.g., into a frame memory, at step S3. The value corresponding to the initial gray level section at which the previous image data was located at time t0 is read out from the frame memory and then delivered to an initial position look-up table. The data returned, at step S4, from the initial position look-up table is the input address of the judge point data look-up table, which, at step S5, returns information of all judge points of the overdrive curve that was found at step S2. The information of all judge points found at step S5 and the current image data are utilized, at step S6, to determine at which target gray level section the current image data is located by the divide-and-rule method. The target gray level section found at step S6 corresponds to the piecewise section needed for overdriving the current image data. According to the information read-out at step S3 and the value corresponding to the target gray level section found at step S6, the parameters of the corresponding polynomial are read out, at step S7, from the overdrive look-up table, e.g., 290, and then delivered to the overdrive calculating unit. The overdrive calculating unit receives the current image data and the parameters of the corresponding polynomial from the overdrive look-up table and then calculates, at step S8, the overdrive value to overdrive the current image data to drive the liquid crystal display panel. For the embodiments disclosed with respect to FIG. 6, steps S4, S5 are omitted, steps S3 and S6 are simultaneously performed, and the results of steps S3 and S6 are both used to perform step S7.

The disclosed embodiments provide a liquid crystal driving method and circuit by utilizing the piecewise characteristic of an overdrive curve to configure the overdrive look-up table in order to reduce the size of the necessary memory and LUT, while still ensuring precise overdrive gray values for achieving the liquid crystal overdrive effect.

The foregoing description of the embodiments of the present invention has been presented for purposes of illustration only. It is not intended to be exhaustive or to limit the invention to the precise form or to exemplary embodiments disclosed. Accordingly, the foregoing description should be regarded as illustrative rather than restrictive. Many modifications and variations will be apparent to those skilled in this art. The embodiments are chosen and described in order to best explain the best mode, thereby to enable persons skilled in the art to understand, make and use the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A driving method of driving a pixel of a display, said method comprising the steps of:
utilizing an overdrive gray value to drive a gray level of said pixel from an initial gray value associated with previous image data to a target gray value of current image data; and
utilizing an overdrive gray value curve to determine said overdrive gray value, wherein said overdrive gray value curve is simulated by a polynomial determined by said initial gray value and said target gray value.

2. The driving method as recited in claim 1, comprising:
simulating said overdrive gray value curve by a number of different polynomials which are arranged successively, in accordance with the target gray value, to define together a piecewise characteristic.

3. The driving method as recited in claim 2, comprising:
selecting said overdrive gray value curve, in accordance with the initial gray value, from a plurality of different overdrive gray value curves which are represented by different piecewise characteristics.

4. The driving method as recited in claim 3, further comprising the steps of:
storing information on the target gray value of the current image data to be used in selecting an overdrive gray value curve for next image data;
retrieving stored information on the target gray value of the previous image data to be used in the selection of the overdrive gray value curve for the current image data;
based on the target gray value of the current image data, selecting a polynomial among the polynomials of the selected overdrive gray value curve for overdriving the pixel; and
using the selected polynomial to calculate the overdrive gray value necessary for overdriving said pixel from the initial gray value associated with the previous image data to the target gray value of the current image data.

5. The driving method as recited in claim 4, wherein:
the step of selecting the polynomial for overdriving the pixel is performed simultaneously with at least one of the steps of storing and retrieving information on the target gray value of the previous or current image data.

6. The driving method as recited in claim 4, wherein:
the step of selecting the polynomial for overdriving the pixel is performed subsequently to the step of retrieving information on the target gray value of the previous image data and utilizes the retrieved information.

7. The driving method as recited in claim 1, further comprising the steps of:
generating an overdrive look-up table having
a plurality of initial gray level sections separated by at least one initial gray value judge point,
a plurality of target gray level sections separated by at least one target gray value judge point, and
polynomial parameters stored for each pair of one of said initial gray level sections and one of said target gray level sections;
utilizing said at least one initial gray value judge point and the target gray value of the current image data to determine at which one of the initial gray level sections said pixel of said current image data is located;
storing a value corresponding to said initial gray level section at which said current image data is located in a frame memory;
reading out a value corresponding to an initial gray level section, at which said previous image data was located, from said frame memory;
utilizing said at least one target gray value judge point and said current image data to determine at which one of the target gray level sections said current image data is located;
utilizing a value corresponding to said target gray level section at which said current image data is located, the value corresponding to said initial gray level section at which said previous image data was located, and said overdrive look-up table to read out polynomial parameters of a corresponding polynomial; and
utilizing said read-our polynomial parameters of said corresponding polynomial and the target gray value of the current data to calculate the overdrive gray value to overdrive said pixel.

8. The driving method as recited in claim 7, wherein said polynomial is a second-order polynomial.

9. The driving method as recited in claim 3, wherein said polynomials are second-order polynomials.

10. The driving method as recited in claim 8, wherein:
the second-order polynomial is expressed by the equation Y=ax²+bx+c wherein a, b, c represent polynomial parameters stored in the look-up table, Y represents the overdrive gray value for overdriving the pixel, and x represents the target gray value of said current image data.

11. The driving method as recited in claim 1, further comprising the steps of:
generating an overdrive look-up table having
a plurality of initial gray level sections separated by at least one initial gray value judge point,
a plurality of target gray level sections separated by at least one target gray value judge point, and
polynomial parameters stored for each pair of one of said initial gray level sections and one of said target gray level sections;
utilizing said at least one initial gray value judge point and the target gray value of the current image data to determine at which one of the initial gray level sections said pixel of said current image data is located;
storing a value corresponding to said initial gray level section at which said current image data is located in a frame memory;
reading out a value corresponding to an initial gray level section, at which said previous image data was located, from said frame memory;
retrieving information on all target gray value judge points corresponding to the read-out value;
utilizing the retrieved information and said current image data to determine at which one of the target gray level sections said current image data is located;
utilizing a value corresponding to said target gray level section at which said current image data is located, the value corresponding to said initial gray level section at which said previous image data was located, and said overdrive look-up table to read out polynomial parameters of a corresponding polynomial; and
utilizing said read-our polynomial parameters of said corresponding polynomial and the target gray value of the current data to calculate the overdrive gray value to overdrive said pixel.

12. A driving circuit for utilizing an overdrive gray value to drive a gray level of a pixel of a display from an initial gray value associated with previous image data to a target gray value of current image data, said circuit comprising:
an overdrive look-up table containing at least one parameter of an overdrive gray value curve;
an overdrive calculating unit for retrieving, based on said initial gray value and said target gray value, said at least one parameter, and using said parameter for polynomial simulation of said overdrive gray value curve to determine the overdrive gray value; and
an image output unit for overdriving the pixel using the overdrive gray value.

13. The driving circuit as recited in claim 12, further comprising:
a first unit for generating, based on the initial gray value, first information corresponding to said overdrive gray value curve among a plurality of different overdrive gray value curves which are represented by different piecewise characteristics, wherein each said piecewise characteristic comprises a number of different polynomials arranged successively;
a second unit for generating, based on the target gray value, second information corresponding to one of the polynomials of the selected overdrive gray value curve for simulation of said overdrive gray value curve and determination of the overdrive gray value.

14. The driving circuit as recited in claim 13, further comprising:
a frame memory for storing the first information received from the first unit on the target gray value of the current image data to be used in selecting an overdrive gray value curve for next image data;
a frame memory controller for retrieving, from the frame memory, stored first information on the target gray value of the previous image data to be used in the selection of the overdrive gray value curve for the current image data.

15. The driving circuit as recited in claim 14, further comprising:
a memory controller for delivering the stored first information and the second information to the look up table, and forwarding the parameters returned from the look up table to the overdrive calculating unit.

16. The driving circuit as recited in claim 15, further comprising:
a further memory controller for delivering the stored first information to a judge point look up table, and forwarding third information on all judge points corresponding to the first information to the second unit,
wherein the second unit is arranged for generating the second information based on the third information and the target gray value.

17. A memory containing a look up table for determining of an overdrive gray value to drive a gray level of a pixel of a display from an initial gray value associated with previous image data to a target gray value of current image data;
a plurality of initial gray level sections separated by at least one initial gray value judge point;
a plurality of target gray level sections separated by at least one target gray value judge point; and
for each pair of one of said initial gray level sections and one of said target gray level sections, parameters of a polynomial;
wherein
said parameters constitute information for simulating a plurality of different overdrive gray value curves which are represented by different piecewise characteristics;
each of said piecewise characteristics corresponds to one of said initial gray level sections and comprises a number of different polynomials arranged successively in accordance with the target gray value; and
each of said polynomials corresponds to one of the target gray level sections.

18. The memory of claim 17, further comprising a judge point look up table that contains information on all target gray value judge points by which the successively arranged polynomials of each piecewise characteristic are separated.
